(19) United States
(12) Patent Application Publication
(10) Pub. No.: US 2008/0189753 A1
(43) Pub. Date: Aug. 7, 2008

(54) Apparatus and Method for Analyzing a Content Stream Comprising a Content Item

(75) Inventors: Jan Alexis Daniel Nesvadba, Eindhoven (NL); Dzevdet Burazerovic, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/814,014

(22) PCT Filed: Jan. 17, 2006
(86) PCT No.: PCT/IB06/50168

§ 371 Date: Jul. 16, 2007

(30) Foreign Application Priority Data
Jan. 19, 2005 (EP) 05100296.2

(51) Int. Cl. H04N 7/173

(52) U.S. Cl. 725/105

(57) ABSTRACT

The invention relates to an apparatus (300) and a method for analyzing a content stream (201) comprising a content item, and to a computer program product enabling a programmable device. The apparatus comprises a content analysis processor (310) for identifying an exact indicator of a boundary (221, 222) of the content item in the content stream, wherein identifying comprises determining a remote indicator (231) being remote from the boundary and analyzing the content stream starting from the remote indicator towards the boundary to identify the exact indicator.

The invention relates to an apparatus and a method for analyzing a content stream comprising a content item, and to a computer program product enabling a programmable device.

US2004/0078811A1 discloses a broadband communication system for communicating program content and schedule data concerning a program start time and a program end time in the form of EPG data (Electronic Program Guide) to a receiver. After a program is broadcast, the actual broadcast start and end times of the program are compared with the EPG data to redefine the EPG data, which may be inaccurate, and to find an actual content of the program in the broadcast stream. The actual broadcast start and end times are provided manually by operators. Alternatively, automated techniques are used for monitoring the actual broadcast start and end times. The automated techniques involve a detection of fade-to-black frames in the broadcast stream.

It is a problem of the system known from US2004/0078811A1 that the actual broadcast start and end times are still not reliably identified in the broadcast stream.

It is desirable to provide an apparatus and a method for analyzing a content stream comprising a content item, which allow identification of an exact indicator of the boundary of the content item with an increased reliability.

According to the present invention, the method comprises the step of
utilizing a content-analysis processor to identify an exact indicator of a boundary of the content item in the content stream, wherein utilizing comprises:
determining a remote indicator being remote from the boundary, and
using the content-analysis processor to analyze the content stream starting from the remote indicator towards the boundary to identify the exact indicator.

In the present invention, the exact indicator of the boundary of the content item is identified on the basis of an initial indicator, which may be inaccurate. The initial indicator, e.g. the EPG data, is used to determine the remote indicator and analyze the content stream from the remote indicator in the direction of the initial indicator. At some point, the boundary of the content item is found by means of the content-analysis processor, and the exact indicator is established.

The initial indicator gives a good indication of the location of the boundary of the content item in the content stream. For example, it is reliable that the remote indicator is in the content item if it is, e.g., 5 or 10 minutes from the initial indicator in the content item. The initial indicator may indicate a start or an end of the content item. For example, in the case of the start, the remote indicator is later in time than the initial indicator so that the remote indicator is likely to be in the content item. Therefore, it is quite reliable that the content analysis of the content stream starts within the content item towards the boundary to be found.

The apparatus of the present invention comprises a content analysis processor for
identifying an exact indicator of a boundary of the content item in the content stream, wherein identifying comprises:
determining a remote indicator being remote from the boundary, and
analyzing the content stream starting from the remote indicator towards the boundary to identify the exact indicator.

The apparatus functions in accordance with the method of the present invention.

These and other aspects of the invention will be further explained and described, by way of example, with reference to the following drawings, in which:

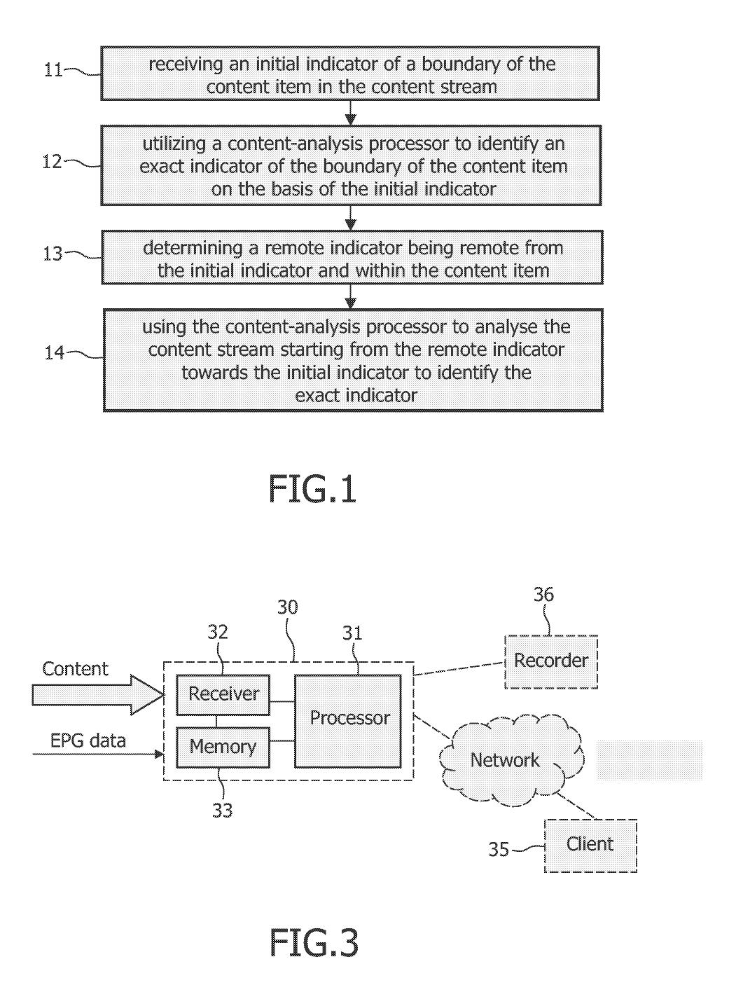

FIG. 1 is an embodiment of the method of the present invention;

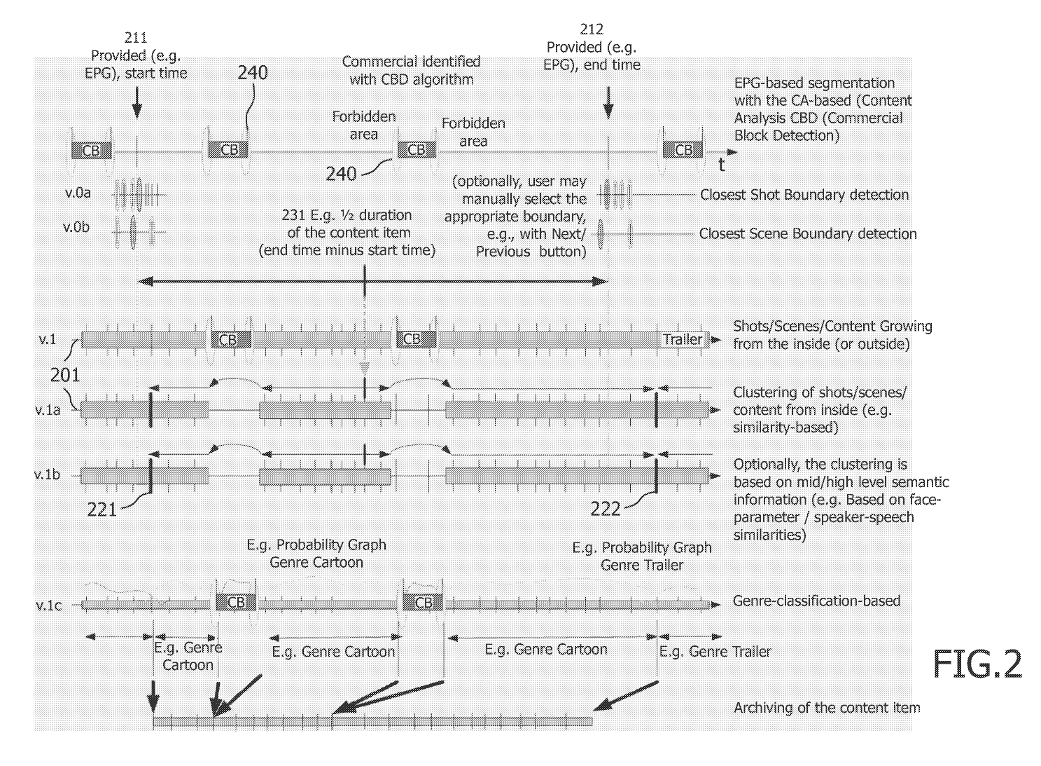

FIG. 2 is a time diagram of a content item in a content stream, wherein a detection of an exact indicator of a boundary of the content item is shown on the basis of EPG data, using a content-analysis method; and

FIG. 3 is a functional block diagram of an embodiment of the apparatus according to the present invention.

Media content providers schedule broadcasts of content items in advance and provide schedule information indicating expected times of broadcasting the content items. At the times of broadcasting, unexpected changes may be made in the schedule but recipients of the broadcast content items are usually not aware of these changes. Sometimes, broadcasters are not able to exactly provide the expected broadcast times. Delays in the transmission of a particular content item may also occur due to a last-minute addition of a trailer or commercial before broadcasting the content item, or due to a delay or an extension of a live event (the content item) such as a soccer game or breaking news. In addition, it may be disadvantageous for the broadcaster to inform the recipients about the exact broadcast times, for example, because the recipients may then no longer watch the commercial inserted between the content items. However, the recipients naturally like to know precisely when the content items are actually transmitted. Knowing the exact broadcast times of the content item, i.e. an exact start and end (boundaries) of the content item, the recipients may avoid recording and/or watching parts of the content stream which do not comprise the desired content item.

The content item may comprise at least one piece, or any combination of visual information (e.g. video images, photos, graphics) and audio information. The expression “audio information”, or “audio content”, is hereinafter used as data pertaining to audio comprising audible tones, silence, speech, music, tranquility, external noise or the like. The audio information may be in formats like the MPEG-1 layer II (mp3) standard (Moving Picture Experts Group), AVI (Audio Video Interleave) format, WMA (Windows Media Audio) format, etc. The expression “video information”, or “video content”, is used as data which are visible such as a motion picture, “still pictures”, video text, etc. The video data may be in formats like GIF (Graphic Interchange Format), JPEG (named after the Joint Photographic Experts Group), MPEG-4, etc.

FIG. 1 shows en embodiment of the method of the present invention, in which the content stream is analyzed to exactly detect boundaries of the content item. In step 110, an initial indicator of the boundary of the content item in the content stream is received, e.g. from the broadcaster, together with or separately from the content item. The initial indicator may indicate an approximate transmission time of the content item. For example, EPG (Electronic Program Guide) data that are known in the state of the art may be used as the initial indicator. The EPG data usually comprise information about start and end broadcast times of TV programs. It should be noted that the EPG is only an example and other services, e.g. PDC/VPS, or data from other databases, e.g. available on or through the Internet, may be used to e.g. indicate or communicate e.g. start and end times.

The content stream may be obtained in any way, for example, in the form of a digital television signal (e.g. in one of the Digital Video Broadcasting formats) received via a satellite, terrestrial, cable, Internet (streaming, Video On Demand, peer-to-peer) or another link. In step 120, the content stream is analyzed by using a content-analysis method to identify an exact indicator of the boundary of the content item on the basis of the initial indicator. The content-analysis method utilizes the initial indicator to determine a starting point whence the analysis of the content stream should be started in order to reliably find the boundary of the content item. The content-analysis method may be performed by a suitably arranged (digital) processor.

A remote indicator is determined in step 130 as the starting point in the content stream to perform the content analysis. The remote indicator is remote from the initial indicator. For example, a particular piece of the content stream is received at the moment of time specified in the EPG (or, as in the case of VHS recorders, by ProgramDeliveryControl/VideoProgrammingSystem) data as the boundary of the content item (i.e. the initial indicator). If that particular piece of the content stream does not really belong to the content item, it is likely that a deviation of the initial indicator from the real boundary of the content item is, e.g., of the order of 15 seconds to 5 or more minutes (or a respective piece of the content stream, e.g., in terms of a number of video frames). A (fixed or variable) threshold may be set to provide a reliable distance from the initial indicator, e.g. a threshold duration or threshold number of video frames, after which the content stream is considered to belong to the content item. The remote indicator may indicate a position in the content stream remote, for the threshold value, from the position indicated by the initial indicator. Since the content item has two boundaries, i.e. the start and the end, the remote indicator should preferably not be outside the content item as indicated by the (start and end) initial indicators. Therefore, the content stream received after the (fixed or variable) threshold is reliable to start the content analysis from.

The initial indicator is used only as a starting reference but as soon as we have found similarity-based clusters, the initial indicator gets a lower priority.

In step 140, the content stream is analyzed, starting from the position indicated by the remote indicator in a direction of the corresponding initial indicator. The content analysis method is applied to the content stream to find the boundary of the content item and thus generate the exact indicator indicating the boundary. Normally, the boundary will be found in the content stream in the vicinity given by the initial indicator.

According to the present invention, it is strictly speaking not mandatory to obtain the initial indicator in order to determine the remote indicator. Step 110 may be optional in the method of the present invention, and no EPG data including the initial indicator may be required. For example, a user may be enabled to manually specify a location in the content stream, which is to be associated with the remote indicator. In other words, the user may select the remote indicator, e.g. by means of manually presetting a time in a DVD recorder, at which time, according to the user, the content item will be broadcast. In this way, the user “informs” the DVD recorder that the content stream will be received by the DVD recorder at the preset time. The DVD recorder will start to analyze the content stream, starting from the position corresponding to the preset time (the remote indicator) in both directions (back in time and forward in time) to detect the content item boundaries. Optionally, instead of receiving the content stream broadcast in real time, the content stream may be pre-recorded and downloaded by the DVD recorder, e.g. from the Internet.

FIG. 2 shows a time diagram indicating a start time 211 and an end time 212 of the content item in the content stream 201 as provided by the initial indicator, e.g. in the EPG data. The content item may have a first boundary 221 and a second boundary 222, which deviate from the start time 211 and the end time 212, respectively. In the example shown in FIG. 2, the content item is received, in reality, somewhat later than it is predetermined and indicated in the EPG data.

Before the remote indicator is determined, the content stream may be processed from a start position corresponding to the start time 211 to an end position corresponding to the end time 212 to verify whether any commercial break occurs. This verification may also be done outside the start time and the end time, because the commercial break could lie close to the start time or the end time. Known commercial detection methods may be used to detect the commercial breaks. For example, a commercial insert 240 is detected in the content stream between the start and end positions. A part of the content stream, where the commercial insert is found, may be of no interest for determining the real boundaries. Therefore, the part of commercial insert may be excluded from the further content analysis (additionally, certain areas around the commercial insert may be marked as “forbidden areas” for the further content analysis). For example, one of the suitable commercial detection methods is described in an article by N. Dimitrova, S. Jeannin, J. Nesvadba, T. McGee, L. Agnihotri, G. Mekenkamp, ‘Real-time commercial detection using MPEG features’, Proc. 9th Int. Conf. On information processing and management of uncertainty in knowledge-based systems (IPMU 2002), pp. 481-486, Annecy, France.

The remote indicator is to be established in the content stream between the start time provided by the initial indicator and the commercial insert 240. The distance between the initial indicator and the remote indicator may be chosen, for example, on the basis of an observed average accuracy of the EPG data of a particular broadcaster, i.e., this may be statistically computed or this may be a mere personal choice of an individual. For example, the remote indicator 231 is adjacent to the beginning of the commercial insert 240 in the content stream, as shown in FIG. 2. Alternatively, a fixed period of time, e.g. 15 seconds to 10 minutes may be taken in the content stream from the initial indicator. In another approach, the remote indicator is in the middle between the start time 211 and the end time 212 (excluding commercial block areas).

Furthermore, the content stream is processed from the position indicated by the remote indicator 231 towards the initial indicator, e.g. the start time 211. The content stream may be analyzed in different manners as long as a transition between the content item and other content is found, and the boundary 221 of the content item is detected.

In one embodiment of the present invention, the content stream is analyzed by using a Shot Boundary Detection (SBD) method known from an article by Dirk Farin, Wolfgang Effelsberg, Peter H. N. de With, “Robust Clustering-Based Video-Summarization with Integration of Domain-Knowledge”, IEEE International Conference on Multimedia and Expo, 1, pp. 89-92, Lausanne, Switzerland, August 2002. A shot is usually composed of consecutive video frames appearing to be defined by a single camera act. Boundaries between video shots in the content stream may be determined, e.g. as places (video frames) where visual parameters, e.g. motion vectors, change from a stationary into a more scattered behavior. The boundaries of the video shots may be indicative of the boundary of the content item. In this embodiment, the boundary, between the shots, which is closest (in the neighborhood of one of the closest) in the content stream to the start time position 211 may be chosen as the (real) boundary of the content item, and the exact indicator is thus generated.

In another embodiment of the present invention, a video scene boundary detection method is used to analyze the content stream starting from the remote indicator 231. Known methods may be applied for the scene boundary detection. For example, the following article discloses a suitable method: J. Nesvadba, N. Louis, J. Benois-Pineau, M. Desainte-Catherine and M. Klein Middelink, “Low-level cross-media statistical approach for semantic partitioning of audio-visual content in a home multimedia environment”, Proc. IEEE IWSSIP'04 (Int. Workshop on Systems, Signals and Image Processing), pp. 235-238, Poznan, Poland, Sep. 13-15, 2004. A scene may correspond to a sequence (cluster) of contiguous video shots, possibly correlated by audio. A scene boundary may be detected as the simultaneous occurrence of the shot boundary and an audio silence break (audio silence of a certain duration) or any other audio transition. The boundary between scenes may be associated with the exact indicator. For example, a scene boundary closest to the initial indicator position may be selected.

In principle, the detection of the boundary and the exact indicator is performed automatically. However, the user may be enabled (using an input means) to manually specify a video shot boundary or a scene boundary different from the automatically selected closest video shot or scene boundary, or any other distinctive transition in the (audio or video) content stream.

Alternatively to selecting the closest scene boundary or the closest shot boundary, it is determined whether a shot or scene boundary belongs to the content item by means of a similarity parameter. For example, the video shots are considered to belong to the same content item if, e.g. color histograms of frames of these shots are similar. Alternatively, video shots or scenes are considered to belong to the same content item if they exhibit audio of the same audio genre or class in general (e.g. speech, music). Therefore, only content blocks (i.e. content sequences, e.g. video shots or video scenes) similar to each other starting from the remote indicator are determined as belonging to the same content item. If, starting from the remote indicator towards the initial indicator, at some point in the content stream no more content blocks may be detected which belong to the same content item, then the boundary of the content item is found at that point.

In another embodiment, the content stream is analyzed, starting from the remote indicator towards the initial indicator and using a genre classification method, which automatically determines a genre of the content item, until a boundary of the content item is detected which corresponds to a position in the content stream where a transition of genres is present. Suitable known genre classification methods may be used for this purpose, for example, as disclosed in WO03010715. For example, the paper by Zhu Liu, Yao Wang, Tsuhan Chen, “Audio feature extraction and analysis for scene segmentation and classification”, Journal of VLSI Signal Processing Systems (special issue on multimedia signal processing), vol. 20, issue 1-2, pp 61-79, October 1998 describes a method of discriminating TV genres such as commercials, basketball games, football games, news reports, and weather forecasts, using a neural network classifier taking only audio features. Statistical pattern classification methods that use both audio and visual features may also be used.

In one embodiment of the present invention, the boundary of the content item may be detected in the content stream by applying an average bit-rate detector disclosed per se in PCT application IB2004/051219 filed by the present Applicant. The average bit-rate may be calculated, starting from the remote indicator towards the initial indicator. The bit-rate, which is a rate of data allocated to a content item in the digital video stream, may be determined. The bit-rate may be indicated as additional information in the digital stream. For example, in digital video broadcasting (DVB), a number of streams carrying video, audio, control data formed into packets of a certain type may be transmitted. With the video data in the packets having a predetermined or indicated size, it is possible to determine the bit rate of the video stream. The average bit rate may be calculated in various ways, e.g. simply for successive periods of time or, alternatively, a moving average of the bit rate may be determined. Of course, other manners of calculating a value of the bit rate over a period of time may be envisaged.

The boundary of the content item may be ascertained on the basis of detecting the change of the average bit rate, for example, by determining a deviation of the average bit rate value exceeding a predetermined threshold, a deviation of the change of the average bit rate value exceeding a certain percentage of said value, etc. The average bit-rate detector has the advantage that the average bit-rate detection is reliable and robust in detecting the boundary of the content item. The determination of the average bit rate over the period of time smoothes variations which do not indicate real changes in the type of content.

In another embodiment, the boundary of the content item is determined by utilizing a Film Mode Detector, known per se from WO2004054256, to analyze the content stream starting from the remote indicator towards the initial indicator. The detector is capable of differentiating between a film (progressive) mode and a video (interlaced) mode. A Holywood feature film is likely to be captured entirely in film mode (3-to-2/2-to-2 pull down) and inserted items adjacent to the film are captured in video mode (cheaper to produce).

FIG. 3 shows an embodiment of an apparatus 300 for analyzing a content stream comprising a content item. The apparatus comprises a (digital data) processor 310 for analyzing the content stream (i.e. a content analysis processor), and, optionally, a receiver 320 and a memory unit 330.

The receiver 320 is arranged to receive the content stream, e.g. digital television signals or digital video signals from the Internet as known in video-on-demand systems, Internet radio networks, etc. The receiver 320 may also be arranged to obtain data, e.g. EPG data, comprising the initial indicator. The memory unit 330 is arranged to store the content stream, which is accessible to the processor 310. The memory unit may be a known RAM (random access memory) memory module, a computer hard disk drive or another storage device.

The processor 310 is arranged to determine the remote indicator on the basis of the initial indicator. The content stream that is received before the remote indicator is determined may be buffered in the memory unit 330. Furthermore, the processor is configured to analyze the content stream from the remote indicator towards the initial indicator to identify the exact indicator. The content stream to be analyzed may be accessed by the processor 310 from the memory unit 330.

The processor 310 may be a central processing unit (CPU) suitably arranged to implement the present invention and enable the operation of the apparatus as explained above with reference to the method. The processor 310 may be configured to read from the memory unit 330 at least one instruction to enable the functioning of the apparatus.

The apparatus 300 may be arranged to include tags of content item boundaries in the content stream and e.g. re-transmit the content stream to a remote client device 350, e.g. via a data network to a TV set or a portable PC. Hence, the apparatus may be incorporated in the service provider equipment, e.g. of a television cable provider.

Alternatively, the content stream with the tags may be communicated to a recorder 360 coupled to the apparatus 300. In other words, the apparatus may be implemented in any one of consumer electronics devices (or multipurpose platform/devices) such as a television set (TV set) with a cable, satellite or other link, a videocassette or HDD-recorder, a home cinema system, a remote control device such as an iPronto remote control, etc.

Variations and modifications of the described embodiments are possible within the scope of the inventive concept. For example, the content stream may be an audio content stream and suitable audio content analysis methods may be applied for the purposes of the present invention.

The processor may execute a software program to enable the execution of the steps of the method of the present invention. The software may enable the apparatus of the present invention independently of where it is being run. To enable the apparatus, the processor may transmit the software program to, for example, the other (external) devices. The independent method claim and the computer program product claim may be used to protect the invention when the software is manufactured or exploited for running on consumer electronics products. The external device may be connected to the processor, using existing technologies, such as Blue-tooth, IEEE 802.11 [a-g], etc. The processor may interact with the external device in accordance with the UPnP (Universal Plug and Play) standard.

A “computer program” is to be understood to mean any software product stored on a computer-readable medium, such as a floppy disk, downloadable via a network, such as the Internet, or marketable in any other manner.

The various program products may implement the functions of the system and method of the present invention and may be combined in several ways with the hardware or located in different devices. The invention can be implemented by means of hardware comprising several distinct elements, and by means of a suitably programmed computer.

1. A method of analyzing a content stream (201) comprising a content item, the method comprising the step of:
utilizing a content-analysis processor to identify an exact indicator of a boundary (221, 222) of the content item in the content stream, wherein utilizing comprises:
determining a remote indicator (231) being remote from the boundary, and
using the content-analysis processor to analyze the content stream starting from the remote indicator towards the boundary to identify the exact indicator.

2. The method of claim 1, wherein the remote indicator is selectable by a user.

3. The method of claim 1, further comprising:
a step of receiving an initial indicator (211, 212) of the boundary of the content item in the content stream.

4. The method of claim 3, wherein the remote indicator is determined on the basis of the initial indicator so that the remote indicator is remote from the initial indicator.

5. The method of claim 4, wherein the content stream is analyzed, starting from the remote indicator towards the initial indicator.

6. The method of claim 3, wherein the initial indicator is EPG data.

7. The method of claim 3, wherein the initial indicator is selectable by a user.

8. The method of claim 1, wherein the content-analysis processor is arranged to automatically determine a genre of the content stream, and detect a transition of genres in the content stream.

9. The method of claim 1, wherein the content-analysis processor is arranged to
identify content blocks in the content stream,
cluster the content blocks if they belong to the content item, and
associate a boundary content block with the exact indicator if no further blocks belonging to the content item are identified.

10. The method of claim 3, wherein the exact indicator is associated with a boundary of a respective one of content blocks in the content stream, the boundary being closest to the initial indicator.

11. The method of claim 9, wherein the content stream is a video stream, and each content block belongs to a respective video scene or a respective video shot.

12. An apparatus (300) for analyzing a content stream (201) comprising a content item, the apparatus comprising a content analysis processor (310) for
identifying an exact indicator of a boundary (221, 222) of the content item in the content stream, wherein identifying comprises:
determining a remote indicator (231) being remote from the boundary, and
analyzing the content stream starting from the remote indicator towards the boundary to identify the exact indicator.

13. The apparatus of claim 12, wherein the remote indicator is selectable by a user.

14. The apparatus of claim 12, wherein the content analysis processor is arranged to receive an initial indicator (211, 212) of the boundary of the content item in the content stream.

15. The apparatus of claim 14, wherein the content analysis processor is arranged to determine the remote indicator on the basis of the initial indicator so that the remote indicator is remote from the initial indicator.

16. The apparatus of claim 15, wherein the content analysis processor is arranged to analyze the content stream starting from the remote indicator towards the initial indicator.

17. A computer program product enabling a programmable device, when executing a computer program of said product, to implement the method of claim 1.
